(19) United States
(12) Patent Application Publication
(10) Pub. No.: US 2026/0259041 A1
(43) Pub. Date: Sep. 3, 2026

(54) MEASURING SYSTEM AND METHOD FOR ROTATION PARAMETERS OF TOP DRIVE MAIN SHAFT

(71) Applicants: China National Petroleum Corporation, Beijing (CN); CNPC Engineering Technology R&D Company Limited, Beijing (CN); Beijing Petroleum Machinery Co., Ltd, Beijing (CN); CNPC Greatwall Drilling Company, Beijing (CN)

(72) Inventors: Bo WANG, Beijing (CN); Fei CHU, Beijing (CN); Xiaoquan WANG, Beijing (CN); Yao ZHANG, Beijing (CN); Guotian ZHANG, Beijing (CN); Ye GAO, Beijing (CN); Quanshui YANG, Beijing (CN); Shuai TAN, Beijing (CN); Tengfei CHEN, Beijing (CN); Bo LI, Beijing (CN); Zeren ZHOU, Beijing (CN); Hongjun ZHANG, Beijing (CN); Rui MA, Beijing (CN)

(21) Appl. No.: 18/873,359

(22) PCT Filed: Oct. 27, 2023
(86) PCT No.: PCT/CN2023/127399

§ 371 Date: Dec. 10, 2024

(30) Foreign Application Priority Data
May 10, 2023 (CN) 202310524364.9

(51) Int. Cl. G01B 11/26; G01S 7/4865; G01S 17/10

(52) U.S. Cl. CPC G01B 11/26; G01S 7/4865; G01S 17/10

(57) ABSTRACT

Embodiments of the present application provide a measuring system and method for rotation parameters of a top drive main shaft, and belong to the technical field of oil and gas drilling equipment. The measuring system includes: a first constant velocity helical disk fixedly disposed on the top drive main shaft and rotating about a shaft axis of the top drive main shaft; a first ranging device, configured to contactlessly acquire a first distance between the first ranging device and a side wall of the first constant velocity helical disk; and a data processing unit, configured to determine a rotational angle of the top drive main shaft according to the first distance and a minimum radius and a maximum radius of the first constant velocity helical disk. With the measuring system of the present application, a measurement value of the rotational angle of the top drive main shaft can still be maintained after the system is powered on again. At the same time, the application is simple in structure and low in manufacturing cost; the application has no mechanical moving parts, so it is highly reliable; the application has high measurement accuracy and is suitable for all kinds of hollow rotating shafts.

### CROSS REFERENCE TO RELATED APPLICATIONS

This application claims the rights of the Chinese patent application 202310524364.9 filed on May 10, 2023, and the content of which is incorporated herein by reference.

### FIELD OF THE INVENTION

The present application relates to the technical field of oil and gas drilling equipment, particularly to a measuring system and method for rotation parameters of a top drive main shaft.

### BACKGROUND OF THE INVENTION

Top drive refers to the top drive drilling device, which usually includes components such as a power swivel and a pipe handling device. The top drive can directly drive the drill string to rotate at the upper part of the derrick space and feed the drill string downward along the special guide rail to complete various drilling operations such as rotary drilling, drilling fluid circulation, stand connecting, making-up and breaking-out, and back-reaming. It can significantly improve the ability and efficiency of drilling operations and has become a standard configuration in the oil drilling industry. Due to the needs of drilling technology, it is hoped that the rotational angle of the top drive main shaft within a certain period of time can be accurately measured, so as to achieve precise control of the rotational angle of the top drive main shaft.

The prior art commonly employs encoders to measure rotational angles. However, when it comes to the top drive main shaft, which is hollow to provide a circulation channel for the drilling fluid, installing encoders directly on the main shaft ends becomes infeasible, posing a challenge for direct measurement. Furthermore, even if indirect measuring methods are employed, they may also encounter certain issues.

For example, in the case of a top drive with the reduction gear transmission, the encoder installed on the motor shaft head can be used to measure the motor's rotational angle, and then the relative rotational angle of the top drive main shaft can be calculated through the reduction ratio. However, for the direct-drive top drive without the reduction gear transmission, an additional pair of speed-increasing gears or speed-increasing pulleys needs to be installed on the top drive main shaft. The encoder measures the rotational angle of the speed-increasing gears, and then the relative rotational angle of the top drive main shaft is calculated through the speed-increasing ratio.

However, both of the above-mentioned indirect measuring methods require the installation of transmission wheels between the encoder and the main shaft, resulting in a complex mechanical structure with a high failure rate. Additionally, due to the backlash between gears, this measuring method is prone to errors and lags. As the usage time increases, gear wear further enlarges the backlash, leading to a further decrease in measurement accuracy.

### SUMMARY OF THE INVENTION

It is an object of embodiments of the present application to provide a measuring system and method for rotation parameters of a top drive main shaft. By utilizing the characteristics of a constant velocity helical disk, it enables precise measurement of the rotational angle (angular displacement) of the top drive main shaft, and the angular displacement information can be maintained even after the system is powered on again.

In order to achieve the above object, an embodiment of the present application provides a measuring system for rotation parameters of a top drive main shaft, and the measuring system includes: a first constant velocity helical disk fixedly disposed on the top drive main shaft and rotating about a shaft axis of the top drive main shaft; a first ranging device, configured to contactlessly acquire a first distance between the first ranging device and a side wall of the first constant velocity helical disk; and a data processing unit, configured to determine a rotational angle of the top drive main shaft according to the first distance and a minimum radius and a maximum radius of the first constant velocity helical disk.

Optionally, prior to rotation of the first constant velocity helical disk and in the case where the first ranging device directly faces the minimum radius of the first constant velocity helical disk, determining the rotational angle of the top drive main shaft comprises:
determining a rotational angle θ of the top drive main shaft according to the first distance L₁, a minimum radius a and a maximum radius b of the first constant velocity helical disk, and a formula as follows,

$$θ = \frac{2 π ( {L}_{01} - {L}_{1} - a )}{b - a} ,$$

wherein L₀₁ is a distance of the first ranging device from the shaft axis.

Optionally, the measuring system further comprises a second ranging device, configured to contactlessly acquire a second distance between the second ranging device and the side wall of the top drive main shaft, and
the data processing unit is further configured to determine a rotational angle of the top drive main shaft based on the first distance, the second distance, and the minimum radius and the maximum radius of the first constant velocity helical disk.

Optionally, prior to rotation of the first constant velocity helical disk and in the case where the first ranging device directly faces the minimum radius of the first constant velocity helical disk, determining the rotational angle of the top drive main shaft comprises:
determining a rotational angle θ of the top drive main shaft according to the first distance L₁, the second distance L₂, the minimum radius a and the maximum radius b of the first constant velocity helical disk, and a formula as follows,

$$θ = \frac{2 π ( {L}_{01} - {L}_{1} + {L}_{02} - {L}_{2} - a )}{b - a} ,$$

wherein L₀₁ is the distance of the first ranging device from the shaft axis; L₀₂ is the distance of the second ranging device from the shaft axis.

Optionally, the data processing unit is further configured to determine an increment Δθ of the rotational angle and a rotational speed ω of the top drive main shaft according to the rotational angles of the top drive main shaft at different times within a same measuring cycle and a formula as follows,

$$Δ θ = {θ}_{1} - {θ}_{0} ,$$

$$ω = \frac{{θ}_{1} - {θ}_{0}}{{t}_{1} - {t}_{0}} ,$$

wherein t₀ is a first time; t₁ is a second time; θ₁ is the rotational angle of the top drive main shaft at t₁; θ₀ is the rotational angle of the top drive main shaft at t₀.

Optionally, the data processing unit is further configured to determine the rotational direction of the top drive main shaft according to a sign of the increment of the rotational angle of the top drive main shaft; and update the rotational angle of the top drive main shaft according to a change in the sign of the increment of the rotational angle and the rotational direction of the top drive main shaft.

Optionally, updating the rotational angle of the top drive main shaft according to the increment of the rotational angle comprises:
updating the rotational angle θ_{update} of the top drive main shaft in a case where the rotational direction of the top drive main shaft indicates that the top drive main shaft rotates in the same direction and the sign of the increment of the rotational angle changes from positive to negative according to the rotational angle θ of the top drive main shaft and a formula as follows,

$${θ}_{u p d a t e} = θ + 2 π ;$$

updating the rotational angle θ_{update} of the top drive main shaft in a case where the rotational direction of the top drive main shaft indicates that the top drive main shaft rotates in the same direction and the sign of the increment of the rotational angle changes from negative to positive according to the rotational angle θ of the top drive main shaft and a formula as follows,

$${θ}_{u p d a t e} = θ - 2 π$$

Optionally, the first ranging device and the second ranging device are laser transmitting and receiving devices.

Optionally, the measuring system further comprises a self-diagnosis unit, configured to receive the second distance; and in a case where the second distance is greater than a set value, the self-diagnosis unit outputs error prompt information.

Optionally, the second ranging device and the first ranging device are distributed on different sides of the shaft axis and at the same distance from the shaft axis.

Optionally, the top drive main shaft further comprises a bearing base on which the first and second ranging devices are fixedly mounted.

Optionally, the measuring system further comprises a counterweight fixedly mounted with the first constant velocity helical disk, wherein an effective center of gravity of both the counterweight and the first constant velocity helical disk is located on the shaft axis.

Optionally, the counterweight is a second constant velocity helical disk.

Optionally, the data processing unit is further configured to determine an absolute position of the top drive main shaft based on the first distance and the minimum radius and the maximum radius of the first constant velocity helical disk.

In another aspect, the present application provides a measuring method for rotational parameters of a top drive main shaft, and the measuring method includes: fixedly disposing a first constant velocity helical disk on the top drive main shaft, wherein the first constant velocity helical disk rotates about a shaft axis of the top drive main shaft; contactlessly acquiring a first distance between a first ranging device and a side wall of the first constant velocity helical disk; and determining a rotational angle of the top drive main shaft based on the first distance and a minimum radius and a maximum radius of the first constant velocity helical disk.

Through the above technical solutions, beneficial effects of the present application are:
this application is primarily focused on non-contact measurement and calculation of the rotational parameters of a top drive main shaft, and provides a complete method to realize non-contact measurement and processing of the rotational angle of the top drive main shaft, thus filling the technical gap in the current stage where non-contact direct measurement of the rotational angle of the top drive main shaft is not available. With the measuring system of this application, the measured value of the rotational angle of the top drive main shaft can be maintained even after the system is powered on again. At the same time, the application is simple in structure and low in manufacturing cost; the application has no mechanical moving parts, so it is highly reliable; the application has high measurement accuracy and is suitable for all kinds of hollow rotating shafts.

Additional features and advantages of embodiments of the present disclosure will be described in detail in the Detailed Description section that follows.

### BRIEF DESCRIPTION OF DRAWINGS

The accompanying drawings are included to provide a further understanding of embodiments of the disclosure and constitute a part of the description, and together with the detailed description below serve to explain, but not to limit, embodiments of the disclosure. In the accompanying drawings:

FIG. 1 is a schematic diagram of a measuring system according to an embodiment of the present disclosure;

FIG. 2 is a schematic perspective view of a measuring system according to an embodiment of the present disclosure;

FIG. 3 is a schematic cross-sectional view of a measuring system according to an embodiment of the present disclosure;

FIG. 4 is a schematic diagram of a measuring system according to an embodiment of the present disclosure;

FIG. 5 is a schematic diagram of a measuring system according to an embodiment of the present disclosure;

FIG. 6 is a schematic diagram of a measuring system according to an embodiment of the present disclosure; and

FIG. 7 is a flowchart of a measuring method according to an embodiment of the present disclosure.

### DESCRIPTION OF REFERENCE SIGNS

1—first ranging device, 2—second ranging device, 3—first constant velocity helical disk, 4—second constant velocity helical disk, 5—data processing unit, 6—control unit, 7—top drive main shaft, 8—bearing, 9—bearing base, 10—bracket, 11—third ranging device.

### DETAILED DESCRIPTION OF THE EMBODIMENTS

Detailed descriptions of embodiments of the present disclosure are set forth below with reference to the appended drawings. It should be understood that the specific embodiments described herein are merely illustrative and explanatory of the embodiments of the present application, and are not intended to limit the embodiments of the present application.

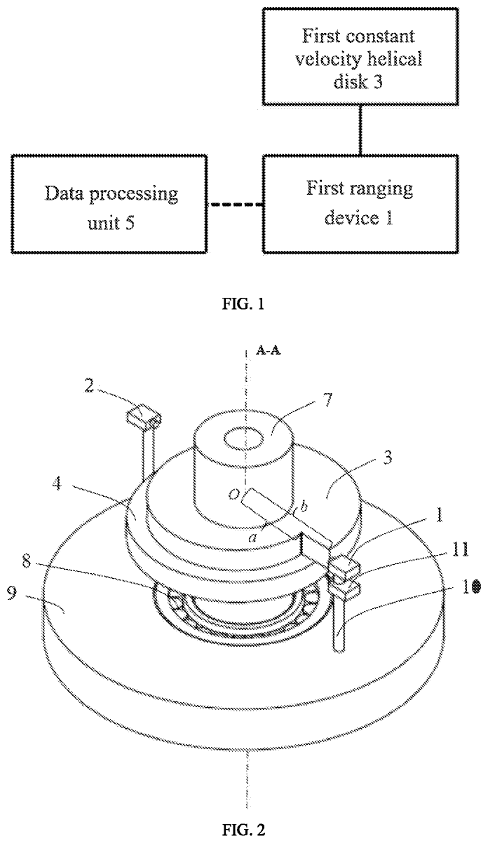

In a first aspect, an embodiment of the present application provides a measuring system for rotation parameters of a top drive main shaft 7, which may include a first constant velocity helical disk 3, a first ranging device 1, and a data processing unit 5, as shown in FIGS. 1-3.

The first constant velocity helical disk 3 may be fixedly disposed on the top drive main shaft 7 and may rotate about the shaft axis A-A of the top drive main shaft 7. The first ranging device 1 is configured to contactlessly acquire a first distance between the first ranging device 1 and a side wall of the first constant velocity helical disk 3.

The data processing unit 5 is configured to determine the rotational angle of the top drive main shaft 7 according to the first distance and a minimum radius and a maximum radius of the first constant velocity helical disk 3. The technical solution of the present application has a beneficial effect of allowing the drilling fluid to pass from the center of the top drive main shaft 7 without installing additional measuring assemblies at both ends of the top drive main shaft 7, and the application is suitable for various types of hollow rotating shafts.

Wherein, FIG. 1 shows a ranging relationship between the first ranging device 1 and the first constant velocity helical disk 3 in a solid line, and a communication relationship between the data processing unit 5 and the first ranging device 1 in a short dashed line.

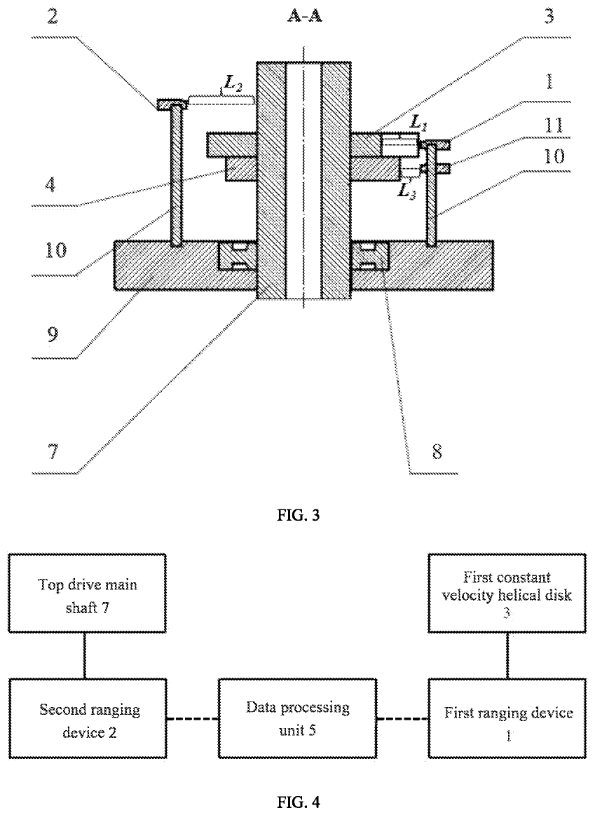

Specifically, as shown in FIGS. 2 and 3, the first constant velocity helical disk 3 may be fixedly provided on the top drive main shaft 7 and may rotate about the shaft axis A-A of the top drive main shaft 7. That is, the origin O of the first constant velocity helical disk 3 is located on the shaft axis A-A of the top drive main shaft 7 so that both of the first constant velocity helical disk 3 and the top drive main shaft 7 can rotate at the same angular velocity. In other words, the rotational angle of the first constant velocity helical disk 3 is the same as that of the top drive main shaft 7. Wherein, the first constant velocity helical disk 3 has a minimum radius a and a maximum radius b, as shown in FIG. 3.

In an embodiment, the minimum radius of the first constant velocity helical disk 3 should be larger than the outer diameter of the top drive main shaft 7, and a mounting hole having an inner diameter not smaller than the outer diameter of the top drive main shaft 7 is provided at the central position of the first constant velocity helical disk 3, so that the first constant velocity helical disk 3 can be mounted on the top drive main shaft 7 through the mounting hole without interfering with the top drive main shaft 7. At the same time, the maximum radius of the first constant velocity helical disk 3 should not be larger than the distance of the first ranging device 1 from the shaft axis A-A, so that the first constant velocity helical disk 3 will not interfere with the first ranging device 1.

The first ranging device 1 is configured to contactlessly acquire the distance between the first ranging device 1 and the side wall of the first constant velocity helical disk 3, referred to as the first distance L₁ (shown in FIG. 3).

In an embodiment, the first ranging device 1 may be a laser emitting and receiving device for emitting a pulsed laser beam and receiving a pulsed laser beam. The pulsed laser beam is directed at and perpendicular to the shaft axis A-A of the top drive main shaft 7, while the pulsed laser beam is irradicated on and is diffusely reflected on the side of the first constant velocity helical disk 3. The laser receiving device receives the diffusely reflected beam, and determines a first distance between the first ranging device 1 and the first constant velocity helical disk 3 according to a time difference of the emitted beam and the received beam. The first ranging device 1 may then convert the distance value into an electrical signal and transmit the electrical signal to the data processing unit 5. The first ranging device 1 may also be other devices capable of ranging contactlessly.

The data processing unit 5 is configured to, according to the first distance and the minimum radius and the maximum radius of the first constant velocity helical disk 3, determine the rotational angle of the first constant velocity helical disk 3 (the rotational angle refers to the angle between the position of the same radius of the first constant velocity helical disk 3 after rotation and its initial position before rotation, in other words, it is also a way to determine the rotational angle of the top drive main shaft 7, which is the angle that the top drive main shaft 7 has rotated since its initial position).

Generally, from a principle level, the data processing unit 5 may determine the rotational angle of the top drive main shaft 7 according to the first distance, the distance of the first ranging device 1 from the shaft axis A-A of the top drive main shaft 7, the radial run-out value of the top drive main shaft 7, the minimum radius and the maximum radius of the first constant velocity helical disk 3.

Specifically, in an embodiment, prior to rotation of the first constant velocity helical disk 3 and in the case where the first ranging device 1 directly faces the minimum radius of the first constant velocity helical disk 3 (with reference to the position shown in FIG. 2), the relationship between the first distance L₁ measured by the first ranging device 1 and the rotational angle θ of the top drive main shaft 7 can be expressed by Formula (1):

$${L}_{1} = {L}_{01} + Δ𝒳 - [ a + \frac{θ}{2 π} ( b - a ) ] , \qquad Formula ( 1 )$$

wherein L₀₁ is the distance of the first ranging device 1 from the shaft axis A-A of the top drive main shaft 7; Δ [symbol] is the radial run-out value of the top drive main shaft 7; a is the minimum radius of the first constant velocity helical disk 3; and b is the maximum radius of the first constant velocity helical disk 3.

In the actual calculation, the radial run-out value Δ [symbol] of the top drive main shaft 7 is related to the radial clearance of the bearing 8 of the top drive main shaft 7, and the tolerance range of the radial clearance is different depending on the nominal inner diameter of the bearing 8. For example, when the bearing 8 has a nominal inner diameter of 140-200 mm, the tolerance range of the radial clearance is typically 2-30 μm. When the nominal inner diameter of the bearing 8 is in the range from 200 mm to 280 mm, the tolerance range of the radial clearance is typically 2-45 μm. It can be seen that the gap between the nominal inner diameter and the radial clearance of the bearing 8 is about 4 orders of magnitude, so that the radial run-out value Δ [symbol] of the top drive main shaft 7 can be neglected in scenarios where the requirements on accuracy are not particularly high.

Therefore, without taking into account the radial run-out value of the top drive main shaft 7, in an embodiment, the data processing unit 5 may determine the rotational angle θ of the top drive main shaft 7 according to the first distance L₁, a minimum radius a and a maximum radius b of the first constant velocity helical disk, the process of which may be calculated by Formula (2):

$$θ = \frac{2 π ( {L}_{01} - {L}_{1} - a )}{b - a} , \qquad Formula ( 2 )$$

wherein L₀₁ is a distance of the first ranging device 1 from the shaft axis A-A of the top drive main shaft 7.

In an embodiment, the data processing unit 5 may also be configured to determine an increment of the rotational angle and the rotational speed of the top drive main shaft 7. In particular, the data processing unit 5 may determine an increment 40 of the rotational angle and a rotational speed ω of the top drive main shaft 7 according to the rotational angles of the top drive main shaft 7 at different times within a same measuring cycle, the process of which may be calculated by Formulas (3) and (4):

$$Δ θ = {θ}_{1} - {θ}_{0} , \qquad Formula ( 3 )$$

$$ω = \frac{{θ}_{1} - {θ}_{0}}{{t}_{1} - {t}_{0}} , \qquad Formula ( 4 )$$

wherein t₀ is a first time; t₁ is a second time; θ₁ is the rotational angle of the top drive main shaft 7 at t₁; θ₀ is the rotational angle of the top drive main shaft 7 at t₀.

In an embodiment, the data processing unit 5 may also be configured to determine the rotational direction of the top drive main shaft 7 according to a sign (or symbol) of the increment of the rotational angle. Specifically, in the case where the radius of the first constant velocity helical disk 3 becomes gradually larger in the clockwise direction, if the sign of the increment of the rotational angle is positive, it indicates that the rotational direction of the top drive main shaft 7 is clockwise; if the sign of the increment of the rotational angle is negative, it indicates that the rotational direction of the top drive main shaft 7 is counterclockwise. In the case where the radius of the first constant velocity helical disk 3 becomes gradually smaller in the clockwise direction, if the sign of the increment of the rotational angle is positive, it indicates that the rotational direction of the top drive main shaft 7 is counterclockwise; if the sign of the increment of the rotational angle is negative, it indicates that the rotational direction of the top drive main shaft 7 is clockwise.

In an embodiment, the data processing unit 5 may also be configured to update the rotational angle of the top drive main shaft 7 according to a change in the sign of the increment of the rotational angle. Specifically, in the case where the rotational direction of the top drive main shaft 7 indicates that the top drive main shaft 7 rotates in the same direction and the sign of the increment of the rotational angle changes from positive to negative, the data processing unit 5 may update the rotational angle θ_{update} of the top drive main shaft 7 according to the rotational angle θ of the top drive main shaft 7, the process of which may be calculated by Formula (5):

$${θ}_{u p d a t e} = θ + 2 π , \qquad Formula ( 5 )$$

In addition, in the case where the rotational direction of the top drive main shaft 7 indicates that the top drive main shaft 7 rotates in the same direction and the sign of the increment of the rotational angle changes from negative to positive, the data processing unit 5 may update the rotational angle θ_{update} of the top drive main shaft 7 according to the rotational angle θ of the top drive main shaft 7, the process of which may be calculated by Formula (6):

$${θ}_{u ρ d a t e} = θ - 2 π , \qquad Formula ( 6 )$$

In an embodiment, as shown in FIG. 4, in order to eliminate interference of the radial run-out value Δ [symbol] of the top drive main shaft 7 to the rotational angle measurement of the top drive main shaft 7, the measuring system may further include: a second ranging device 2 configured to contactlessly acquire the distance between the second ranging device 2 and the side wall of the top drive main shaft 7, referred to as a second distance L₂ (shown in FIG. 3). The data processing unit 5 may also be configured to determine the rotational angle of the top drive main shaft 7 based on the first distance, the second distance and the minimum radius and the maximum radius of the first constant velocity helical disk.

Wherein, FIG. 4 shows the ranging relationship between the second ranging device 2 and the top drive main shaft 7 in a solid line and the communication relationship between the data processing unit 5 and the second ranging device 2 in a short dashed line.

In an embodiment, the second ranging device 2 and the first ranging device 1 may be located anywhere on the top drive main shaft 7. That is, the three of the top drive main shaft 7, the first ranging device 1 and the second ranging device 2 may or may not be collinear. In the case where the three are not collinear, the radial run-out value Δ [symbol] of the top drive main shaft 7 can be determined by an angle formed by taking the top drive main shaft 7 as the vertex, the first distance L₁ and the second distance L₂ as the two sides, and the second distance L₂.

In a preferred embodiment, the second ranging device 2 and the first ranging device 1 may be distributed on different sides of the top drive main shaft 7. That is, the top drive main shaft 7 is located in the middle of the first ranging device 1 and the second ranging device 2, which are collinear, so that ranging interference between the two sets of ranging devices with each other can be eliminated. In this case, the data processing unit 5 may determine the radial run out value of the top drive main shaft 7 from the second distance and the distance of the second ranging device 2 from the shaft axis A-A of the top drive main shaft 7. Further, according to the first distance, the distance of the first ranging device 1 from the shaft axis A-A of the top drive main shaft 7, the minimum radius and the maximum radius of the first constant velocity helical disk 3, the rotational angle of the top drive main shaft 7 can be determined.

In particular, the radial run-out value Δ [symbol] of the top drive main shaft 7 can be determined by the second distance L₂, the process of which can be calculated by Formula (7):

$$Δ𝒳 = {L}_{02} - {L}_{2} , \qquad Formula ( 7 )$$

wherein, L₀₂ is the distance of the second ranging device 2 from the shaft axis A-A of the top drive main shaft 7.

In an embodiment, prior to rotation of the first constant velocity helical disk 3 and in the case where the first ranging device 1 directly faces the minimum radius of the first constant velocity helical disk 3, the data processing unit 5 can determine the rotational angle θ of the top drive main shaft 7 according to the first distance L₁, the second distance L₂ and the minimum radius a and the maximum radius b of the first constant velocity helical disk 3, thereby automatically compensating for the radial run-out error due to the bearing clearance when the top drive main shaft 7 rotates, eliminating the error due to the radial run out of the top drive main shaft 7, and making the calculation more accurate. The process can be calculated by Formula (8):

$$θ = \frac{2 π ( {L}_{01} - {L}_{1} + {L}_{02} - {L}_{2} - a )}{b - a} , \qquad Formula ( 8 )$$

wherein, L₀₁ is the distance of the first ranging device 1 from the shaft axis A-A of the top drive main shaft 7; L₀₂ is the distance of the second ranging device 2 from the shaft axis A-A of the top drive main shaft 7.

In an embodiment, the second ranging device 2 may be a laser emitting and receiving device for emitting a pulsed laser beam and receiving a pulsed laser beam. The pulsed laser beam is directed at and perpendicular to the shaft axis A-A of the top drive main shaft 7, while the pulsed laser beam is irradicated on and is diffusely reflected on the side of the top drive main shaft 7. The laser receiving device receives the diffusely reflected beam, and determines a first distance between the second ranging device 2 and the top drive main shaft 7 according to a time difference of the emitted beam and the received beam. The second ranging device 2 may then convert the distance value into an electrical signal and transmit the electrical signal to the data processing unit 5. This second ranging device 2 may also be other devices capable of ranging contactlessly.

In an embodiment, the second ranging device 2 and the first ranging device 1 may be axially symmetric about the shaft axis A-A in a top view perspective. The distance of the first ranging device 1 and the second ranging device 2 from the shaft axis A-A of the top drive main shaft 7 is thereby made the same to simplify the calculation process. In this case, Formula (8) can be simplified to Formula (9):

$$θ = \frac{2 π ( 2 {L}_{0} - {L}_{1} - {L}_{2} - a )}{b - a} , \qquad Formula ( 9 )$$

wherein, θ is the rotational angle of the top drive main shaft 7; L₀ is the distance of the first ranging device 1 from the shaft axis A-A of the top drive main shaft 7; L₁ is the first distance; L₂ is the second distance; a is the minimum radius of the first constant velocity helical disk 3; b is the maximum radius of the first constant velocity helical disk 3.

In an embodiment, the measuring system may further include a self-diagnosis unit for receiving the second distance. Meanwhile in a case where the second distance is greater than the set value, that is, when the second ranging device 2 detects that the amount of distance change exceeds the maximum clearance allowed by the bearing 8, then the self-diagnosis unit considers that the data is erroneous and outputs an error prompt information. There are generally two reasons for this situation: the ranging function of the second ranging device 2 is malfunctioning, or the amount of wear of the top drive main shaft 7 is too large. Therefore, the self-diagnosis unit can transmit prompt information to the second ranging device 2 or the data processing unit 5, and at the same time instruct to stop the ranging operation or the data processing operation.

In an embodiment, the measuring system may further include a counterweight fixedly mounted with the first constant velocity helical disk 3. At the same time, the effective center of gravity of both the counterweight and the first constant velocity helical disk 3 is located on the shaft axis A-A of the top drive main shaft 7, thereby preventing vibration due to eccentricity from affecting the ranging accuracy.

Wherein, the counterweight may be a second constant velocity helical disk 4. The second constant velocity helical disk 4 is fixedly disposed to the top drive main shaft 7 and rotates about the shaft axis A-A of the top drive main shaft 7. That is, the origin of the second constant velocity helical disk 4 is also located on the shaft axis A-A of the top drive main shaft 7 so as to be able to rotate at the same angular velocity as the first constant velocity helical disk 3 and the top drive main shaft 7.

In this case, as shown in FIG. 5, the measuring system may further include a third ranging device 11 configured to contactlessly acquire the distance between the third ranging device 11 and the side wall of the second constant velocity helical disk 4, referred to as a third distance L₃ (shown in FIG. 3). The data processing unit 5 may also be configured to determine the rotational angle of the top drive main shaft 7 based on the third distance and the minimum radius and the maximum radius of the second constant velocity helical disk 4. Thus, the third ranging device 11 and the second constant velocity helical disk 4 can serve as a backup to the first ranging device 1 and the first constant velocity helical disk 3 of the measuring system.

For example, the first ranging device 1 may be switched to the third ranging device 11 when the first ranging device 1 is out of service (e.g., maintenance or replacement); when the first ranging device 1 resumes operation, the third ranging device 11 may be switched back to the first ranging device 1. The backup ranging device is thereby turned on or off, so that the continuous ranging operation to the top drive main shaft 7 is not affected when the first ranging device 1 is maintained or replaced.

Wherein, FIG. 5 shows the ranging relationship between the third ranging device 11 and the second constant velocity helical disk 4 in a solid line, and the communication relationship between the data processing unit 5 and the third ranging device 11 in a short dashed line.

Specifically, the second constant velocity helical disk 4 may be fixedly disposed to the top drive main shaft 7 and may rotate about the shaft axis A-A of the top drive main shaft 7. That is, the origin of the second constant velocity helical disk 4 is located on the shaft axis A-A of the top drive main shaft 7 so that both can rotate at the same angular velocity. In other words, the rotational angle of the second constant velocity helical disk 4 and that of the top drive main shaft 7 are the same. Wherein the second constant velocity helical disk 4 has a minimum radius c and a maximum radius d.

In an embodiment, the minimum radius of the second constant velocity helical disk 4 should be larger than the outer diameter of the top drive main shaft 7, and a mounting hole whose inner diameter should not be smaller than the outer diameter of the top drive main shaft 7 is provided at the center position of the second constant velocity helical disk 4, so that the second constant velocity helical disk 4 can be mounted on the top drive main shaft 7 through the mounting hole without interfering with the top drive main shaft 7. At the same time, the maximum radius of the second constant velocity helical disk 4 should not be larger than the distance of the third ranging device 11 from the shaft axis A-A, so that the second constant velocity helical disk 4 will not interfere with the third ranging device 11.

In an embodiment, the third ranging device 11 may be a laser emitting and receiving device for emitting a pulsed laser beam and receiving a pulsed laser beam. The pulsed laser beam is directed at and perpendicular to the shaft axis A-A of the top drive main shaft 7, while the pulsed laser beam is irradicated on and is diffusely reflected on the side of the second constant velocity helical disk 4. The laser receiving device receives the diffusely reflected beam, and determines a third distance between the third ranging device 11 and the second constant velocity helical disk 4 according to a time difference of the emitted beam and the received beam. The third ranging device 11 may then convert the distance value into an electrical signal and transmit the electrical signal to the data processing unit 5. This third ranging device 11 may also be other devices capable of non-contact ranging.

In an embodiment, the data processing unit 5 may be configured to, according to the third distance and the minimum and maximum radii of the second constant velocity helical disk 4, determine the rotational angle of the second constant velocity helical disk 4 (the rotational angle refers to the angle between the position of the same radius of the second constant velocity helical disk 4 after rotation and its initial position before rotation, in other words, it is also a way to determine the rotational angle of the top drive main shaft 7, which is the angle that the top drive main shaft 7 has rotated since its initial time).

Specifically, in an embodiment, prior to rotation of the second constant velocity helical disk 4 and in the case where the third ranging device 11 directly faces the minimum radius of the second constant velocity helical disk 4, the relationship between the third distance L₃ measured by the third ranging device 11 and the rotational angle θ of the top drive main shaft 7 can be expressed by Formula (10).

$${L}_{3} = {L}_{03} + Δ𝒳 - [ c + \frac{θ}{2 π} ( d - c ) ] , \qquad Formula ( 10 )$$

wherein, L₀₃ is the distance of the third ranging device 11 from the shaft axis A-A of the top drive main shaft 7; Δ [symbol] is the radial run-out value of the top drive main shaft 7; c is the minimum radius of the second constant velocity helical disk 4; and d is the maximum radius of the second constant velocity helical disk 4.

Without considering the radial run-out value of the top drive main shaft 7, in an embodiment, the data processing unit 5 may determine the rotational angle θ of the top drive main shaft 7 from the third distance L₃ and the minimum radius c and the maximum radius d of the second constant velocity helical disk 4, the process of which may be calculated by Formula (11):

$$θ = \frac{2 π ( {L}_{03} - {L}_{3} - c )}{d - c} , \qquad Formula ( 11 )$$

wherein, L₀₃ is the distance of the third ranging device 11 from the shaft axis A-A of the top drive main shaft 7.

Considering the radial run-out value of the top drive main shaft 7, in an embodiment, prior to the rotation of the second constant velocity helical disk 4 and in the case where the third ranging device 11 directly faces the minimum radius of the second constant velocity helical disk 4, the data processing unit 5 can determine the rotational angle θ of the top drive main shaft 7 according to the third distance L₃, the second distance L₂, and the minimum radius c and the maximum radius d of the second constant velocity helical disk 4, thereby automatically compensating for the radial run-out error due to the bearing clearance when the top drive main shaft 7 rotates, eliminating the error due to the radial run out of the top drive main shaft 7, and making the calculation more accurate. The process can be calculated by Formula (12):

$$θ = \frac{2 π ( {L}_{03} - {L}_{3} + {L}_{02} - {L}_{2} - c )}{d - c} , \qquad Formula ( 12 )$$

wherein, L₀₃ is the distance of the third ranging device 11 from the shaft axis A-A of the top drive main shaft 7; L₀₂ is the distance of the second ranging device 2 from the shaft axis A-A of the top drive main shaft 7.

In an embodiment, the second constant velocity helical disk 4 is the same shape as the first constant velocity helical disk 3. In this case, the maximum radius d of the second constant velocity helical disk 4 is the same as the maximum radius b of the first constant velocity helical disk 3, and the minimum radius c of the second constant velocity helical disk 4 is the same as the minimum radius a of the first constant velocity helical disk 3. At the same time, the maximum radius of the second constant velocity helical disk 4 is located at a position opposite to the maximum radius of the first constant velocity helical disk 3, so as to ensure that the effective center of gravity of both the second constant velocity helical disk 4 and the first constant velocity helical disk 3 is located on the shaft axis A-A of the top drive main shaft 7.

In an embodiment, the positions of the first ranging device 1, the second ranging device 2 and the third ranging device 11 may be relatively fixed. For example, the top drive main shaft 7 may further include a bearing base 9 to which the first, second and third ranging devices 1, 2, 11 are fixedly mounted. This way of mounting may allow the positions of the first ranging device 1, the second ranging device 2 and the third ranging device 11 to be relatively fixed even if there is some disturbance in the outside, so that errors due to the outside interference may be eliminated. Preferably, the three of the first ranging device 1, the second ranging device 2, and the third ranging device 11 can be fixedly mounted to the bearing base 9 by the brackets 10, so that the heights of the three can be adjusted according to the actual situation to better range the target object. More preferably, the four of the first ranging device 1, the third ranging device 11, the top drive main shaft 7 and the second ranging device 2 are collinear. Wherein, both the first ranging device 1 and the third ranging device 11 are fixedly mounted on one side of the top drive main shaft 7 and the second ranging device 2 is fixedly mounted on the other side of the top drive main shaft 7.

In an embodiment, the sides of the first ranging device 1, the second ranging device 2 and the third ranging device 11 may also be mounted with a guard.

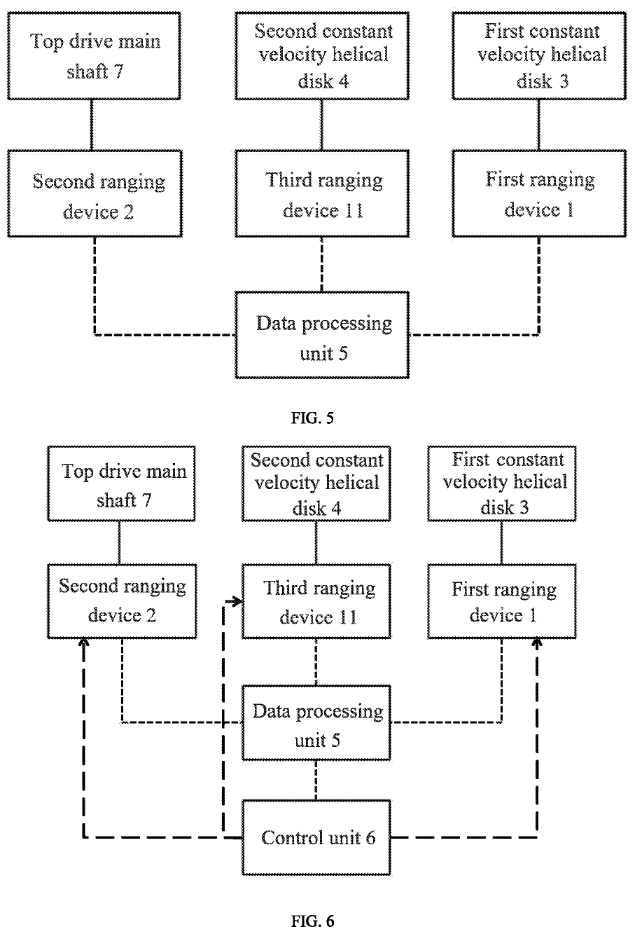

In an embodiment, as shown in FIG. 6, the measuring system may further include a control unit 6, configured to receive data processing information of the data processing unit 5 and control one or more of the above-mentioned first ranging device 1, second ranging device 2 and third ranging device 11 based on the data processing information. Wherein, FIG. 6 shows the communication relationship between the data processing unit 5 and the control unit 6 in a short dashed line, and a control relationship of the first ranging device 1, the second ranging device 2, and the third ranging device 11 by the control unit 6 is shown with long dashed lines.

Specifically, this data processing information includes a rotational angle, a rotational direction, a rotation speed of the top drive main shaft 7. Optionally, the control unit 6 may instruct to control whether the first ranging device 1, the second ranging device 2 and the third ranging device 11 perform ranging work according to the top drive operating condition to extend the service life of the ranging devices.

In an optional embodiment, the control unit 6 may instruct to switch the first ranging device 1 and the second ranging device 2 to operate at different times, eliminating ranging interference (e.g. pulsed laser beam interference) between the two sets of ranging devices.

In another optional embodiment, the control unit 6 may instruct to switch the first ranging device 1 to the third ranging device 11 when the first ranging device 1 is out of service (e.g., maintenance or replacement); when the first ranging device 1 resumes working, it is instructed to switch the third ranging device 11 back to the first ranging device 1. The backup ranging device is thereby turned on or off, so that the continuous ranging operation to the top drive main shaft 7 is not affected when the first ranging device 1 is maintained or replaced.

In an embodiment, the data processing unit 5 may further be configured to determine the absolute position of the top drive main shaft 7 from the first distance. This is because the present application is a separate device for measuring and calculating the rotational angle of the top drive main shaft, and the measured value at any time can be converted to a unique angular value, so that the angular information can be maintained even after the system is powered on again. The encoders in the prior art typically use grating code disks, i.e., a number of optically transmissive code tracks are uniformly etched in the circumferential direction on a disk substrate, which can be made of glass, metal, or other materials. However, such encoders can only measure relative angular displacement of the rotating shaft, cannot measure absolute position information of the rotating shaft, and therefore cannot maintain information after the system is powered on again.

In this embodiment, specifically, the reference position of the top drive main shaft 7 at the initial moment (corresponding to the initial position prior to the rotation of the first constant velocity helical disk 3) is h₀, if prior to the rotation of the first constant velocity helical disk 3, the first ranging device 1 directly faces the smallest radius of the first constant velocity helical disk 3, then during the same measurement period (i.e. the first constant velocity helical disk rotates less than one circle), the absolute position h of the top drive main shaft 7 can be determined from the first distance L₁ measured at any time, the reference position h₀ and the minimum radius a and the maximum radius b of the first constant velocity helical disk 3, which can be calculated by Formula (13):

$$h = {h}_{0} + \frac{m ( {L}_{01} - {L}_{1} - a )}{b - a} , \qquad Formula ( 13 )$$

wherein, L₀₁ is the distance of the first ranging device 1 from the shaft axis A-A of the top drive main shaft 7; and m is the spacing between two adjacent rotating threads of the top drive main shaft 7.

In the case of multiple measurement cycles (i.e., the first constant velocity helical disk rotates more than one circle), the absolute position h of the top drive main shaft 7 can then be determined from the first distance L₁ measured at any time, the number of circles n (calculated as the number of times the sign of the increment of the rotational angle of the top drive main shaft 7 changes), the reference position h₀ and the minimum radius a and the maximum radius b of the first constant velocity helical disk 3, which can be calculated by Formula (14):

$$h = {h}_{0} + \frac{m ( {L}_{01} - {L}_{1} - a )}{b - a} + nm , \qquad Formula ( 14 )$$

wherein, L₀₁ is the distance of the first ranging device 1 from the shaft axis A-A of the top drive main shaft 7; and m is the spacing between two adjacent rotating threads of the top drive main shaft 7.

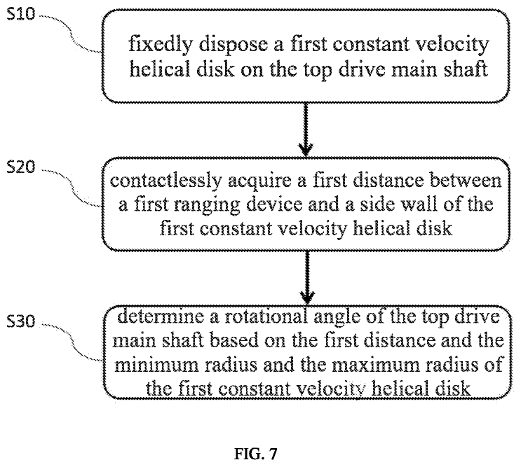

In another aspect, the present application provides a measuring method for rotational parameters of a top drive main shaft, as shown in FIG. 7, the measuring method includes: S10, a first constant velocity helical disk is fixedly disposed on the top drive main shaft, wherein the first constant velocity helical disk rotates around a shaft axis of the top drive main shaft; S20, a first distance between the first ranging device and the side wall of the first constant velocity helical disk is contactlessly acquired; and S30, the rotational angle of the top drive main shaft is determined according to the first distance and the minimum radius and the maximum radius of the first constant velocity helical disk.

In an embodiment, prior to the rotation of the first constant velocity helical disk and in the case where the first ranging device directly faces the minimum radius of the first constant velocity helical disk (referring to the position shown in FIG. 2), the step that the rotational angle of the top drive main shaft is determined may include determining the rotational angle θ of the top drive main shaft from the first distance L₁ and the minimum radius a and the maximum radius b of the first constant velocity helical disk, which process may be calculated by Formula (2).

$$θ = \frac{2 π ( {L}_{01} - {L}_{1} - a )}{b - a} , \qquad Formula ( 2 )$$

wherein, L₀₁ is the distance of the first ranging device from the shaft axis of the top drive main shaft.

In an embodiment, the measuring method may further include: determining the increment of the rotational angle and the rotational speed of the top drive main shaft. Determining the increment of the rotational angle and the rotational speed of the top drive main shaft includes determining the increment Δθ of the rotational angle ω and the rotational speed of the top drive main shaft from the rotational angles of the top drive main shaft at different times within the same measurement cycle, which process can be calculated by Formulas (3) and (4):

$$Δ θ = {θ}_{1} - {θ}_{0} , \qquad Formula ( 3 )$$

$$ω = \frac{{θ}_{1} - {θ}_{0}}{{t}_{1} - {t}_{0}} , \qquad Formula ( 4 )$$

wherein, t₀ is a first time; t₁ is a second time; θ₁ is the rotational angle of the top drive main shaft at t₁; θ₀ is the rotational angle of the top drive main shaft at t₀.

In an embodiment, the measuring method may further include: determining the rotational direction of the top drive main shaft according to the sign of the increment of the rotational angle; and updating the rotational angle of the top drive main shaft according to the change in the sign of the increment of the rotational angle.

In an embodiment, updating the rotational angle of the top drive main shaft according to the change in the sign of the increment of the rotational angle may include updating the rotational angle θ_{update} of the top drive main shaft 7 according to the rotational angle θ of the top drive main shaft in the case where the top drive main shaft rotates in the same direction and the sign of the increment of the rotational angle changes from positive to negative, the process of which may be calculated by Formula (5):

$${θ}_{update} = θ + 2 π , \qquad Formula ( 5 )$$

In addition, in the case wherein the top drive main shaft rotates in the same direction and the sign of the increment of the rotational angle changes from negative to positive, the rotational angle θ_{update} of the top drive main shaft 7 is updated according to the rotational angle θ of the top drive main shaft, the process of which can be calculated by Formula (6):

$${θ}_{update} = θ - 2 π , \qquad Formula ( 6 )$$

In an embodiment, the measuring method may further include contactlessly acquiring a second distance between the second ranging device and the side wall of the top drive main shaft, and determining the rotational angle of the top drive main shaft according to the first distance, the second distance, and the minimum radius and the maximum radius of the first constant velocity helical disk.

Wherein, in an embodiment, prior to rotation of the first constant velocity helical disk and in the case where the first ranging device directly faces a minimum radius of the first constant velocity helical disk, determining the rotational angle of the top drive main shaft may include: determining the rotational angle θ of the top drive main shaft according to the first distance L₁, the second distance L₂, and the minimum radius a and the maximum radius b of the first constant velocity helical disk, thereby automatically compensating for the radial run-out error due to the bearing clearance when the top drive main shaft 7 rotates, eliminating the error due to the radial run out of the top drive main shaft 7, and making the calculation more accurate. The process can be calculated by Formula (8):

$$θ = \frac{2 π ( {L}_{01} - {L}_{1} + {L}_{02} - {L}_{2} - a )}{b - a} , \qquad Formula ( 8 )$$

wherein, L₀₁ is the distance of the first ranging device from the shaft axis; L₀₂ is the distance of the second ranging device from the shaft axis.

In an embodiment, the first ranging device and the second ranging device may be laser transmitting and receiving devices.

In an embodiment, the measuring method may further include outputting an error prompt information in a case where the second distance is greater than a set value.

In an embodiment, the second ranging device and the first ranging device may be distributed on different sides of the shaft axis at the same distance from the shaft axis.

In an embodiment, the top drive main shaft may further include a bearing base, and the first ranging device and the second ranging device may be fixedly mounted on the bearing base.

In an embodiment, the measuring method may further include fixedly providing a counterweight on the first constant velocity helical disk, wherein the effective center of gravity of both the counterweight and the first constant velocity helical disk is located on the shaft axis.

In one embodiment, the counterweight may be a second constant velocity helical disk.

In an embodiment, the measuring method may further include determining an absolute position of the top drive main shaft based on the first distance and a minimum radius and a maximum radius of the first constant velocity helical disk.

The specific details and benefits of the measuring method for the rotational parameters of the top drive main shaft provided by the embodiments of the present application can be referred to the above description for the measuring system for the rotational parameters of the top drive main shaft, which will not be described in detail here.

It should also be noted that the terms “comprises”, “comprising”, or any other variation thereof are intended to encompass a non-exclusive inclusion such that a process, method, commodity, or apparatus comprising a series of elements includes not only those elements, but also other elements not explicitly listed, or elements inherent to such a process, method, commodity, or apparatus. Without further limitation, an element defined by the statement “comprising a” does not preclude the presence of additional identical elements in the process, method, article, or apparatus comprising the element.

The above are only examples of the present application, and are not used to limit the present application. Various modifications and variations of the present application will occur to those skilled in the art. It is intended that any modifications, equivalents, improvements, and the like within the spirit and principles of the present application be included within the scope of the claims of the present application.

1. A measuring system for rotational parameters of a top drive main shaft, comprising:
a first constant velocity helical disk fixedly disposed on the top drive main shaft and rotating about a shaft axis of the top drive main shaft;
a first ranging device, configured to contactlessly acquire a first distance between the first ranging device and a side wall of the first constant velocity helical disk; and
a data processing unit, configured to determine a rotational angle of the top drive main shaft according to the first distance and a minimum radius and a maximum radius of the first constant velocity helical disk.

2. The measuring system according to claim 1, wherein prior to rotation of the first constant velocity helical disk and in the case where the first ranging device directly faces the minimum radius of the first constant velocity helical disk, determining the rotational angle of the top drive main shaft comprises:
determining a rotational angle θ of the top drive main shaft according to the first distance L₁, a minimum radius a and a maximum radius b of the first constant velocity helical disk, and a formula as follows,
$$θ = \frac{2 π ( {L}_{01} - {L}_{1} - a )}{b - a} ,$$
wherein L₀₁ is a distance of the first ranging device from the shaft axis.

3. The measuring system according to claim 1, further comprising a second ranging device, configured to contactlessly acquire a second distance between the second ranging device and the side wall of the top drive main shaft, and
the data processing unit is further configured to determine a rotational angle of the top drive main shaft based on the first distance, the second distance, and the minimum radius and the maximum radius of the first constant velocity helical disk.

4. The measuring system according to claim 3, wherein prior to rotation of the first constant velocity helical disk and in the case where the first ranging device directly faces the minimum radius of the first constant velocity helical disk, determining the rotational angle of the top drive main shaft comprises:
determining a rotational angle θ of the top drive main shaft according to the first distance L₁, the second distance L₂, the minimum radius a and the maximum radius b of the first constant velocity helical disk, and a formula as follows,
$$θ = \frac{2 π ( {L}_{01} - {L}_{1} + {L}_{02} - {L}_{2} - a )}{b - a} ,$$
wherein L₀₁ is the distance of the first ranging device from the shaft axis; L₀₂ is the distance of the second ranging device from the shaft axis.

5. The measuring system according to claim 4, wherein the data processing unit is further configured to determine an increment Δθ of the rotational angle and a rotational speed ω of the top drive main shaft according to the rotational angles of the top drive main shaft at different times within a same measuring cycle and a formula as follows,
$$Δθ = {θ}_{1} - {θ}_{0} ,$$
$$ω = \frac{{θ}_{1} - {θ}_{0}}{{t}_{1} - {t}_{0}} ,$$
wherein t₀ is a first time; t₁ is a second time; θ₁ is the rotational angle of the top drive main shaft at t₁; θ₀ is the rotational angle of the top drive main shaft at t₀.

6. The measuring system according to claim 5, wherein the data processing unit is further configured to determine the rotational direction of the top drive main shaft according to a sign of the increment of the rotational angle of the top drive main shaft; and update the rotational angle of the top drive main shaft according to a change in the sign of the increment of the rotational angle and the rotational direction of the top drive main shaft.

7. The measuring system according to claim 6, wherein updating the rotational angle of the top drive main shaft according to the increment of the rotational angle comprises:
updating the rotational angle θ_{update} of the top drive main shaft in a case where the rotational direction of the top drive main shaft indicates that the top drive main shaft rotates in the same direction and the sign of the increment of the rotational angle changes from positive to negative according to the rotational angle θ of the top drive main shaft and a formula as follows,
$${θ}_{update} = θ + 2 π ;$$
and
updating the rotational angle θ_{update} of the top drive main shaft in a case where the rotational direction of the top drive main shaft indicates that the top drive main shaft rotates in the same direction and the sign of the increment of the rotational angle changes from negative to positive according to the rotational angle θ of the top drive main shaft and a formula as follows,
$${θ}_{update} = θ - 2 π .$$

8. The measuring system according to claim 3, wherein the first ranging device and the second ranging device are laser transmitting and receiving devices.

9. The measuring system according to claim 3, further comprising:
a self-diagnosis unit, configured to receive the second distance; and in a case where the second distance is greater than a set value, the self-diagnosis unit outputs error prompt information.

10. The measuring system according to claim 3, wherein the second ranging device and the first ranging device are distributed on different sides of the shaft axis and at the same distance from the shaft axis.

11. The measuring system according to claim 10, wherein the top drive main shaft further comprises a bearing base on which the first and second ranging devices are fixedly mounted.

12. The measuring system according to claim 1, further comprising a counterweight fixedly mounted with the first constant velocity helical disk, wherein an effective center of gravity of both the counterweight and the first constant velocity helical disk is located on the shaft axis.

13. The measuring system according to claim 12, wherein the counterweight is a second constant velocity helical disk.

14. The measuring system according to claim 1, wherein the data processing unit is further configured to determine an absolute position of the top drive main shaft based on the first distance and the minimum radius and the maximum radius of the first constant velocity helical disk.

15. A measuring method for rotational parameters of a top drive main shaft, comprising:
fixedly disposing a first constant velocity helical disk on the top drive main shaft, wherein the first constant velocity helical disk rotates about a shaft axis of the top drive main shaft;
contactlessly acquiring a first distance between a first ranging device and a side wall of the first constant velocity helical disk; and
determining a rotational angle of the top drive main shaft based on the first distance and a minimum radius and a maximum radius of the first constant velocity helical disk.
